(19) United States
(12) Patent Application Publication
(10) Pub. No.: US 2018/0362848 A1
(43) Pub. Date: Dec. 20, 2018

(54) LIQUID CRYSTAL POLYESTER COMPOSITION AND MOLDED ARTICLE

(71) Applicant: Sumitomo Chemical Company, Limited, Tokyo (JP)

(72) Inventors: Kyungbae KIM, Pyeongtaek-si, Gyeonggi-do (KR); Xinli HU, Xuhui District, Shanghai (CN); Tomoyuki HARA, Tsukuba-shi, Ibaraki (JP)

(21) Appl. No.: 15/781,734

(22) PCT Filed: Dec. 7, 2016
(86) PCT No.: PCT/JP2016/086390

§ 371 Date: Jun. 6, 2018

(30) Foreign Application Priority Data
Dec. 9, 2015 (JP) 2015-240453

(51) Int. Cl. C09K 19/38

(52) U.S. Cl. CPC C09K 19/3809; C09K 2219/01

(57) ABSTRACT

A liquid crystal polyester composition containing a liquid crystal polyester, a fibrous filler having a number average fiber diameter of at least 15 μm but not more than 25 μm, and a plate-like filler is provided. The total amount of the fibrous filler and the plate-like filler is at least 65 parts by mass but not more than 105 parts by mass per 100 parts by mass of the liquid crystal polyester.

### TECHNICAL FIELD

The present invention relates to a liquid crystal polyester composition and a molded article.

Priority is claimed on Japanese Patent Application No. 2015-240453, filed Dec. 9, 2015, the content of which is incorporated herein by reference.

### BACKGROUND ART

One known example of an electronic component connector is a CPU socket which is used for detachably mounting a CPU (central processing unit) to an electronic circuit board. A liquid crystal polyester resin having excellent heat resistance and the like is employed as the molding material for forming the CPU socket.

As electronic equipment has increased in performance and the like, the circuit scale of CPUs mounted on electronic circuit boards has also increased. In general, as the scale of CPUs increases, the number of connection pins also increases. In recent years, CPUs having about 700 to 1,000 connection pins have become known. The CPU connection pins are arranged on the bottom surface of the CPU, for example in a matrix-like arrangement. If the size of the CPU remains constant, then the pitch between these connection pins tends to narrow as the number of connection pins increases.

A CPU socket has a plurality of pin insertion holes, which correspond with each of the connection pins of the CPU and form a lattice. As the pitch between the connection pins narrows, the pitch between the pin insertion holes also narrows, and the resin portions that separate adjacent pin insertion holes, namely the lattice walls, become thinner. As a result, in a CPU socket, the greater the number of pin insertion holes, the more likely it becomes that stress during reflow mounting or pin insertion or the like may act upon these walls, with this stress causing damage to the lattice (hereinafter also referred to as cracking).

In this manner, electronic component connectors such as CPU sockets require an improvement in the resistance to post-molding cracking.

Conventionally, liquid crystal polyester compositions containing a fibrous filler added to the liquid crystal polyester are known to improve the mechanical strength of Molded articles.

For example, Patent Document 1 discloses a reinforced liquid crystal resin composition obtained by adding at least 5 parts by weight but not more than 200 parts by weight of a combination of a glass fiber having an average fiber diameter of at least 3 μm but less than 10 μm and a glass fiber having an average fiber diameter of at least 10 μm but less than 20 μm per 100 parts by weight of a prescribed liquid crystal polyester resin.

Patent Document 2 discloses an asymmetric electronic component molded from a liquid crystal polymer composition comprising (A) a fibrous filler having an average fiber diameter of 5 to 30 μm and a weight average fiber length of 250 to 350 μm excluding fibers with a fiber length of not more than 10 μm, and having a proportion of fibers with a fiber length of 700 μm or greater of not more than 5% by weight, and (B) a plate-like filler having an average particle diameter of 0.5 to 200 μm, wherein the total fill amount of the components (A) and (B) in the composition is from 40 to 60% by weight, the weight fraction of the component (A) is from 10 to 20% by weight, the weight fraction of the component (B) is from 30 to 40% by weight, and the asymmetric electronic component has no symmetry relative to any of the XY axial plane, the YZ axial plane or the XZ axial plane of the molded article.

Patent Document 3 discloses a planar connector formed from a composite resin composition comprising (A) a liquid crystal polymer having a p-hydroxybenzoic acid residue content of not more than 55 mol % and having a inciting point of 330° C. or higher, (B) a plate-like inorganic filler, and (C) a fibrous filler having a weight average fiber length of 250 to 600 μm, wherein the amount of the component (B) relative to the entire composition is from 25 to 35% by weight, the amount of the component (C) relative to the entire composition is from 10 to 25% by weight, and the total amount of the component (B) and the component (C) relative to the entire composition is from 40 to 50% by weight, and the planar connector has a structure in which the inside of an outer frame has a lattice structure, the inside of the lattice structure has an opening, the pitch interval of the lattice portion is not more than 1.5 mm, and the ratio between the thickness of the outer frame portion and the thickness of the lattice portion is not more than 0.8.

Patent Document 4 discloses a liquid crystal polyester composition having 100 parts by mass of a liquid crystal polyester, and a total of at least 65 parts by mass but not more than 100 parts by mass of a fibrous filler and a plate-like filler, wherein the fibrous filler has a number average fiber diameter of at least 5 μm but not more than 15 μm and a number average fiber length that is longer than 200 μm but less than 400 μm, the mass ratio of the fibrous filler relative to the sheet-like filler is at least 3 but not more than 15, and the flow starting temperature is at least 250° C. but less than 314° C.

Patent Document 5 discloses a liquid crystal polyester composition comprising a liquid crystal polyester, a plate-like filler having a volume average particle diameter of at least 14 μm, and a fibrous filler, wherein the total amount of the plate-like filler and the fibrous filler is from 45 to 55% by mass relative to the total mass of the liquid crystal polyester composition, and the mass ratio (B/A) of the amount (B) of the fibrous filler relative to the amount (A) of the plate-like filler is greater than 0.5 but not more than 0.65.

### PRIOR ART LITERATURE

### Patent Documents

Patent Document 1: JP H03-243648-A
Patent Document 2: WO 2008-023839
Patent Document 3: WO 2009-141996
Patent Document 4: JP 2013-194165-A
Patent Document 5: JP 2012-107221-A

### SUMMARY OF INVENTION

### Problems to be Solved by the Invention

The liquid crystal polyester compositions disclosed in the above Patent Documents 1 to 5 do not exhibit entirely satisfactory resistance to post-molding cracking of the molded articles such as CPU sockets, and further improvement is required.

The present invention has been developed in light of these circumstances, and has an object of providing a liquid crystal polyester composition that forms a molded article having excellent crack resistance. Further, the present invention also has the objects of providing a method for producing this type of liquid crystal polyester composition and a molded article molded from the liquid crystal polyester composition.

### Means for Solving the Problems

The present invention includes the following aspects [1] to [8].

[1] A liquid crystal polyester composition comprising a liquid crystal polyester, a fibrous filler having a number average fiber diameter of at least 15 μm but not more than 25 μm, and a plate-like filler, wherein

the total amount of the fibrous filler and the plate-like filler is at least 65 parts by mass but not more than 105 parts by mass per 100 parts by mass of the liquid crystal polyester.

[2] The liquid crystal polyester composition according to [1], wherein per 100 parts by mass of the liquid crystal polyester, the amount of the fibrous filler is at least 5 parts by mass but not more than 26 parts by mass, and the amount of the plate-like filler is at least 45 parts by mass but not more than 82 parts by mass.

[3] The liquid crystal polyester composition according to [1] or [2], wherein the weight average fiber length of the fibrous filler is greater than 300 μm but not more than 600 μm.

[4] The liquid crystal polyester composition according to any one of [1] to [3], wherein the volume average particle diameter of the plate-like filler is at least 1.5 μm but not more than 40 μm.

[5] The liquid crystal polyester composition according to any one of [1] to [4], wherein the plate-like filler is a mica.

[6] A molded article molded from the liquid crystal polyester composition according to any one of [1] to [5].

[7] The molded article according to [6], wherein the molded article is a connector.

[8] The molded article according to [7], wherein the connector is a CPU socket.

### Effects of the Invention

The present invention can provide a liquid crystal polyester composition that forms a molded article having excellent crack resistance. Further, the present invention can also provide a method for producing this type of liquid crystal polyester composition, and a molded article molded from the liquid crystal polyester composition.

### BRIEF DESCRIPTION OF THE DRAWINGS

FIG. 1A is a schematic plan view illustrating a connector of an embodiment of the present invention.

FIG. 1B is a cross-sectional view along the line A-A in FIG. 1A.

FIG. 2 is a schematic view illustrating a connector of an embodiment of the present invention, and represents an enlarged view of the region B in FIG. 1A.

### EMBODIMENTS FOR CARRYING OUT THE INVENTION

### <Liquid Crystal Polyester Composition>

A liquid crystal polyester composition that represents a first aspect of the present invention comprises a liquid crystal polyester, a fibrous filler having a number average fiber diameter of at least 15 μm but not more than 25 μm, and a plate-like filler, wherein the total amount of the fibrous filler and the plate-like filler is at least 65 parts by mass but not more than 105 parts by mass per 100 parts by mass of the liquid crystal polyester.

Because the liquid crystal polyester composition comprises the fibrous filler having a number average fiber diameter of at least 15 μm but not more than 25 μm, and has a total amount of the fibrous filler and the plate-like filler that falls within the above prescribed range, a molded article molded from the liquid crystal polyester composition is resistant to deformation under high-temperature conditions (for example, the 200 to 250° C. that represents the temperature used during re-flow heating). As a result, a molded article molded from the liquid crystal polyester composition of the present invention has improved resistance to cracking, meaning the occurrence of cracking can be suppressed.

The total amount of the fibrous filler and the plate-like filler per 100 parts by mass of the liquid crystal polyester is preferably at least 70 parts by mass but not more than 90 parts by mass, more preferably at least 75 parts by mass but not more than 85 parts by mass, and even more preferably at least 78 parts by mass but not more than 83 parts by mass. Further, in another aspect, the total amount of the fibrous filler and the plate-like filler per 100 parts by mass of the liquid crystal polyester may be at least 65 parts by mass but not more than 100 parts by mass, may be at least 67 parts by mass but not more than 1.00 parts by mass, or may be at least 67 parts by mass but not more than 82 parts by mass. Provided the total amount of the fibrous filler and the plate-like filler is at least as large as the above lower limit, the occurrence of cracking in the molded article molded from the liquid crystal polyester composition tends to better suppressed, whereas provided the total amount is not more than the above upper limit, the fluidity of the liquid crystal polyester composition tends to be satisfactory.

In the liquid crystal polyester composition of this embodiment, it is preferable that, relative to 100 parts by mass of the liquid crystal polyester, the amount of the fibrous filler is at least 5 parts by mass but not more than 26 parts by mass and the amount of the plate-like filler is at least 15 parts by mass but not more than 82 parts by mass, and it is more preferable that the amount of the fibrous filler is at least 7 parts by mass but not more than 55 parts by mass and the amount of the plate-like filler is at least 45 parts by mass but not more than 82 parts by mass.

By including amounts of the fibrous filler and the plate-like filler that satisfy these ranges, a molded article can be obtained that exhibits little warping before and after reflow treatment.

The liquid crystal polyester composition may be obtained by mixing together the liquid crystal polyester, the fibrous filler and the plate-like filler (namely, a mixture of powders), or may be obtained by melt kneading of the various components, and for example, processing into a pellet-like form.

### <<Liquid Crystal Polyester>>

The liquid crystal polyester according to the present invention is described below.

The liquid crystal polyester in the liquid crystal polyester composition that represents one embodiment of the present invention may be a liquid crystal polyester, a liquid crystal polyester amide, a liquid crystal polyester ether, a liquid crystal polyester carbonate, or a liquid crystal polyester imide. The liquid crystal polyester according to the present invention is preferably a fully aromatic liquid crystal polyester obtained by polymerizing only aromatic compounds as the raw material monomers.

Typical examples of the liquid crystal polyester according to the present invention include: those obtained by polymerizing (polycondensing) an aromatic hydroxycarboxylic acid, an aromatic dicarboxylic acid, and at least one compound selected from the group consisting of aromatic diols, aromatic hydroxyamines and aromatic diamines; those obtained by polymerizing a plurality of aromatic hydroxycarboxylic acids; those obtained by polymerizing an aromatic dicarboxylic acid and at least one compound selected from the group consisting of aromatic diols, aromatic hydroxyamines and aromatic diamines; and those obtained by polymerizing a polyester such as polyethylene terephthalate and an aromatic hydroxycarboxylic acid. Here, each of the aromatic hydroxycarboxylic acids, aromatic dicarboxylic acids, aromatic diols, aromatic hydroxyamines and aromatic diamines may, independently, be partially or completely replaced with a polymerizable derivative of one of these compounds.

Examples of polymerizable derivatives of the compounds having a carboxyl group such as the aromatic hydroxycarboxylic acids and aromatic dicarboxylic acids include compounds in which the carboxyl group has been converted to an alkoxycarboxyl group or an aryloxycarbonyl group (namely, esters), compounds in which the carboxyl group has been converted to a haloformyl group (namely, acid halides), and compounds in which the carboxyl group has been converted to an acyloxycarbonyl group (namely, acid anhydrides). Examples of polymerizable derivatives of the compounds having a hydroxyl group such as the aromatic hydroxycarboxylic acids, aromatic diols and aromatic hydroxyamines include compounds in which the hydroxyl group has been acylated and converted to an acyloxy group (namely, acylated compounds). Examples of polymerizable derivatives of the compounds having an amino group such as the aromatic hydroxyamines and aromatic diamines include compounds in which the amino group has been acylated and converted to an acylamino group (namely, acylated compounds).

The liquid crystal polyester according to the present invention preferably has a repeating unit represented by formula (1) shown below (hereinafter sometimes referred to as “the repeating unit (1)”), and more preferably has the repeating unit (1), a repeating unit represented by formula (2) shown below (hereinafter sometimes referred to as “the repeating unit (2)”), and a repeating unit represented by formula (3) shown below (hereinafter sometimes referred to as “the repeating unit (3)”).

—O—Ar¹—CO— (1)

—CO—Ar²—CO— (2)

—X—Ar³—Y— (3)

(Ar¹ represents a phenylene group, a naphthylene group, or a biphenylylene group;

each of Ar² and Ar³ independently represents a phenylene group, a naphthylene group, a biphenylylene group, or a group represented by formula (4);

each of X and Y independently represents an oxygen atom or an amino group (—NH—); and

hydrogen atoms in a group represented by Ar¹, Ar² or Ar³ may each be independently substituted with a halogen atom, an alkyl group of 1 to 10 carbon atoms or an aryl group of 6 to 20 carbon atoms.)

—Ar⁴—Z—Ar⁵— (4)

(In formula (4), each of Ar⁴ and Ar⁵ independently represents a phenylene group or a naphthylene group;

Z represents an oxygen atom, sulfur atom, carbonyl group, sulfonyl group or alkylidene group of 1 to 10 carbon atoms; and

hydrogen atoms in a group represented by Ar⁴ or Ar⁵ may each be independently substituted with a halogen atom, an alkyl group of 1 to 10 carbon atoms or an aryl group of 6 to 20 carbon atoms.)

Examples of the halogen atom include a fluorine atom, chlorine atom, bromine atom and iodine atom.

Examples of the alkyl group of 1 to 10 carbon atoms include a methyl group, ethyl group, n-propyl group, isopropyl group, n-butyl group, isobutyl group, sec-butyl group, tert-butyl group, n-hexyl group, 2-ethylhexyl group, n-octyl group and n-decyl group.

Examples of the aryl group of 6 to 20 carbon atoms include a phenyl group, o-tolyl group, m-tolyl group, p-tolyl group, 1-naphthyl group and 2-naphthyl group.

In those cases where a hydrogen atom in the group represented by Ar¹, Ar² or Ar³ is substituted by a halogen atom, an alkyl group of 1 to 10 carbon atoms or an aryl group of 6 to 20 carbon atoms, the number of groups which substitute a hydrogen atom in each group represented by Ar¹, Ar² or Ar³ is, independently, preferably not more than two, and is more preferably one.

Examples of the alkylidene group of 1 to 10 carbon atoms include a methylene group, ethylidene group, isopropylidene group, n-butylidene group and 2-ethylhexylidene group.

In those cases where a hydrogen atom in the group represented by Ar⁴ or A⁵ is substituted by a halogen atom, an alkyl group of 1 to 10 carbon atoms or an aryl group of 6 to 20 carbon atoms, the number of groups which substitute a hydrogen atom in each group represented by Ar⁴ or Ar⁵ is, independently, preferably not more than two, and is more preferably one.

The repeating unit (1) is a repeating unit derived from a specific aromatic hydroxycarboxylic acid. The repeating unit (1) is preferably a repeating unit derived from p-hydroxybenzoic acid (namely, where Ar¹ is a p-phenylene group) or a repeating unit derived from 6-hydroxy-2-naphthoic acid (namely, where Ar¹ is a 2,6-naphthylene group).

The repeating unit (2) is a repeating unit derived from a specific aromatic dicarboxylic acid. The repeating unit (2) is preferably a repeating unit in which Ar² is a p-phenylene group (for example, a repeating unit derived from terephthalic acid), a repeating unit in which Ar² is an m-phenylene group (for example, a repeating unit derived from isophthalic acid), or a repeating unit in which Ar² is a 2,6-naphthylene group (for example, a repeating unit derived from 2,6-naphthalenedicarboxylic acid).

The repeating unit (3) is a repeating unit derived from a specific aromatic diol, aromatic hydroxylamine or aromatic diamine. The repeating unit (3) is preferably a repeating unit in which Ar³ is a p-phenylene group (for example, a repeating unit derived from hydroquinone, p-aminophenol or p-phenylenediamine), or a repeating unit in which Ar³ is a 4,4′-biphenylylene group (for example, a repeating unit derived from 4,4′-dihydroxybiphenyl, 4-amino-4′-hydroxybiphenyl or 4,4′-diaminobiphenyl).

In this description, “derived” means a change in the chemical structure due to polymerization.

In those cases where the liquid crystal polyester according to the present invention includes the repeating unit (1), the repeating unit (2) and the repeating unit (3), the amount of the repeating unit (1), when the total of the repeating unit (1), the repeating unit (2) and the repeating unit (3) is deemed to be 100 mol %, is preferably at least 30 mol %, more preferably at least 30 mol % but not more than 80 mol %, even more preferably at least 40 mol % but not more than 70 mol %, and even more preferably at least 45 mol % but not more than 65 mol %.

Similarly, the amount of the repeating unit (2), when the total of the repeating unit (1), the repeating unit (2) and the repeating unit (3) in the liquid crystal polyester is deemed to be 100 mol %, is preferably not more than 35 mol %, more preferably at least 10 mol % but not more than 35 mol %, even more preferably at least 15 mol % but not more than 30 mol %, and even more preferably at least 17.5 mol % but not more than 27.5 mol %.

Similarly, the amount of the repeating unit (3), when the total of the repeating unit (1), the repeating unit (2) and the repeating unit (3) in the liquid crystal polyester is deemed to be 100 mol %, is preferably not more than 35 mol %, more preferably at least 10 mol % but not more than 35 mol %, even more preferably at least 15 mol % but not more than 30 mol %, and even more preferably at least 17.5 mol % but not more than 27.5 mol %.

Provided the amount of the repeating unit (1) falls within the above range, the melt fluidity, the heat resistance, and the strength and rigidity of the liquid crystal polyester can be more easily improved.

The ratio between the amount of the repeating unit (2) and the amount of the repeating unit (3), when represented by [amount of repeating unit (2)]/[amount of repeating unit (3)] (mol/mol), is preferably from 0.9/1 to 1/0.9, more preferably from 0.95/1 to 1/0.95, and even more preferably from 0.98/1 to 1/0.98.

The liquid crystal polyester according to the present invention may have two or More types of each of the repeating units (1) to (3). Further, the liquid crystal polyester may have other repeating units besides the repeating units (1) to (3), but the amount of those other repeating units, when the total amount of all the repeating units that constitute the liquid crystal polyester is deemed to be 100 mol %, is preferably at least 0 mol % but not more than 10 mol %, and more preferably at least 0 mol % but not more than 5 mol %.

In another aspect, in the liquid crystal polyester according to the present invention, the amount of at least one repeating unit selected from the group consisting of the repeating units (1) to (3), when the total amount of all the repeating units that constitute the liquid crystal polyester is deemed to be 1.00 mol %, is preferably at least 90 mol % but not more than 100 mol %, and more preferably at least 95 mol % but not more than 100 mol %.

In order to lower the melt viscosity of the liquid crystal polyester according to the present invention, it is preferable that X and Y in the repeating unit (3) both represent oxygen atoms (namely, a repeating unit derived from an aromatic diol). Because the melt viscosity of the liquid crystal polyester can be lowered by increasing the amount of the repeating unit (3) in which X and Y are both oxygen atoms, the melt viscosity of the liquid crystal polyester can be altered as required by controlling the amount of the repeating unit (3) in which X and Y are both oxygen atoms.

In one aspect of a method for producing the liquid crystal polyester according to the present invention, in order to enable a high-molecular weight liquid crystal polyester having superior heat resistance, strength and rigidity to be produced with good operability, it is preferable that the liquid crystal polyester is produced by performing a melt polymerization of the raw material monomers corresponding with the repeating units that constitute the liquid crystal polyester, and subjecting the thus obtained polymer (hereinafter sometimes referred to as a prepolymer) to a solid phase polymerization. The melt polymerization may be performed in the presence of a catalyst. Examples of this catalyst include metal compounds such as magnesium acetate, stannous acetate, tetrabutyl titanate, lead acetate, sodium acetate, potassium acetate and antimony trioxide, and nitrogen-containing heterocyclic compounds such as 4-(dimethylamino)pyridine and 1-methylimidazole, and of these, nitrogen-containing heterocyclic compounds are preferable.

The flow starting temperature of the liquid crystal polyester according to the present invention is preferably from 270° C. to 400° C., and more preferably from 280° C. to 380° C. When the flow starting temperature falls within this type of range, the fluidity of the liquid crystal polyester is more favorable, and the heat resistance (for example, the blister resistance in those cases where the molded article is an electronic component connector such as a CPU socket) also improves. Further, thermal degradation when melt molding is performed during production of the molded article from the liquid crystal polyester is better suppressed.

The “flow starting temperature” is also referred to as the flow temperature or the fluidizing temperature, and is the temperature that yields a viscosity of 4,800 Pa·s (48,000 poise) when the liquid crystal polyester is melted by heating at a rate of temperature increase of 4° C./minute under a load of 9.8 MPa (100 kg/cm²) using a capillary rheometer, and extruded from a nozzle having an inner diameter of 1 mm and a length of 10 mm, and is a temperature that acts as an indicator of the molecular weight of the liquid crystal polyester (see Naoyuki Koide (ed.), “Liquid Crystal Polymers-Synthesis, Molding, Applications”, CMC Publishing Co., Ltd., Jun. 5, 1987, p. 95).

A single type of the liquid crystal polyester may be used alone, or a combination of two or more types may be used. When two or more types are used, the combination and ratio between the components may set as desired.

The amount of the liquid crystal polyester according to the present invention relative to the total mass of the liquid crystal polyester composition is preferably from 48 to 61% by mass.

### <<Fibrous Filler>>

The fibrous filler in the liquid crystal polyester composition that represents one embodiment of the present invention has a number average fiber diameter of at least 15 μm but not more than 25 μm, and preferably at least 16 μm but not more than 24 μm. A single type of the fibrous filler may be used alone, or a combination of two or more types may be used.

By ensuring that the number average fiber diameter of the fibrous filler in the liquid crystal polyester composition is of this type of size, cracking can be suppressed in the molded articles molded from the obtained liquid crystal polyester composition.

Examples of the fibrous filler include glass fiber; carbon fiber such as PAN-based carbon fiber and pitch-based carbon fiber; ceramic fiber such as silica fiber, alumina fiber and silica-alumina fiber; and metal fiber such as stainless steel fiber. Additional examples include whiskers such as potassium titanate whiskers, barium titanate whiskers, wollastonite whiskers, aluminum borate whiskers, silicon nitride whiskers and silicon carbide whiskers.

Among these, glass fiber, potassium titanate whiskers, wollastonite whiskers and aluminum borate whiskers are preferable, and glass fiber is more preferable.

Examples of the glass fiber include glass fiber produced by any of various methods, including long fiber-type chopped glass fiber and short fiber-type milled glass fiber, and a combination of these two types of fiber may also be used.

The glass fiber may have been treated with a surface treatment agent such as a coupling agent like a silane-based coupling agent or a titanium-based coupling agent.

In terms of mechanical strength, a weakly alkaline glass fiber is preferable. A glass fiber having a silicon oxide content, relative to the total mass of the glass fiber, of 50 to 80% by mass is preferable, and a glass fiber having a silicon oxide content, relative to the total mass of the glass fiber, of 65 to 77% by mass is more preferable.

The glass fiber may be coated or bundled with a thermoplastic resin such as a urethane resin, acrylic resin or ethylene/vinyl acetate copolymer, or a thermosetting resin such as an epoxy resin.

Examples of fibrous organic fillers include polyester fiber and aramid fiber.

The weight average fiber length of the fibrous filler is preferably greater than 300 μm but not more than 600 μm, more preferably greater than 300 μm but less than 600 μm, and even more preferably greater than 350 μm but not more than 500 μm.

Provided the weight average fiber length of the fibrous filler falls within the above range, the occurrence of warping before and after reflow tends to be better suppressed.

The “number average fiber diameter” and the “weight average fiber length” of the fibrous filler can be measured by observation using a microscope such as a digital microscope. A specific method is described below.

One gram of resin composition pellets are incinerated by heating at 600° C. for 4 hours. The incinerated residue containing the fibrous filler is dispersed in an ethylene glycol solution and after application of ultrasonic waves for 3 minutes, a few drops of the dispersion are dripped onto a side glass. Following disentangling to prevent overlap of the fibrous filler fibers on the slide glass, a cover glass is placed on top of the slide glass. Using a video microscope (VHX-600, manufactured by Keyence Corporation), the focus is adjusted to display the outlines of the fibrous filler fibers, and the number average fiber diameter and the weight average fiber length is measured for 500 fibrous filler fibers at a magnification of 100×.

The weight average fiber length (L_{w}) can be calculated using the following formula, where Nᵢ represents the number of fibers each having a fiber length (Lᵢ), a density (ρᵢ) and a fiber diameter (rᵢ).

L_{w}=Σ(Nᵢ×τ×rᵢ²×Lᵢ²×ρᵢ)/Σ(Nᵢ×τ×rᵢ²×Lᵢ×ρᵢ)

The liquid crystal polyester composition of the present embodiment preferably contains the fibrous filler in an amount that is at least 5 parts by mass but not more than 26 parts by mass, more preferably at least 6 parts by mass but not more than 25 parts by mass, even more preferably at least 7 parts by mass but not more than 24 parts by mass, and particularly preferably at least 9 parts by mass but not more than 23 parts by mass, per 100 parts by mass of the above liquid crystal polyester.

In the liquid crystal polyester composition of this embodiment, by ensuring that the amount of the fibrous filler is at least as large as the above lower limit, the molded article molded from the liquid crystal polyester composition is able to exhibit a level of strength that makes deformation under high-temperature conditions unlikely. Further, by ensuring that the amount is not more than the above upper limit, the filling properties of the liquid crystal polyester composition are favorable, and the strength of any weld that occurs in the molded article also tends to be favorable.

The amount of the fibrous filler in the liquid crystal polyester composition of the present invention is preferably from 3 to 15% by mass relative to the total mass of the liquid crystal polyester composition.

### <<Plate-Like Filler>>

Examples of the plate-like filler according to the present invention include talc, mica, graphite, wollastonite, glass flakes, barium sulfate and calcium carbonate. The mica may be muscovite, phlogopite, fluorphlogopite or tetrasilic mica. A talc or mica is preferable, and a mica is more preferable. A single type of the plate-like filler may be used alone, or a combination of two or more types may be used.

The plate-like filler may have been treated with an aforementioned surface treatment agent.

From the viewpoint of improving the resistance to cracking of the molded article molded from the liquid crystal polyester composition of the present embodiment, the volume average particle diameter of the plate-like filler in the liquid crystal polyester composition is preferably at least 15 μm but not more than 40 μm, more preferably at least 20 μm but not more than 30 μm, and particularly preferably at least 22 μm but not More than 28 μm.

Provided the volume average particle diameter of the plate-like filler is at least as large as the above lower limit, the crack resistance of the molded article molded from the liquid crystal polyester composition tends to improve further. Furthermore, provided the volume average particle diameter of the plate-like filler is not more than the above upper limit, the occurrence of warping before and after reflow tends to be better suppressed.

The volume average particle diameter of the plate-like filler can be determined by a laser diffraction method, and specifically, can be measured by a laser diffraction method under the following conditions.

Measurement Conditions

Measurement apparatus: laser diffraction/scattering particle size distribution analyzer (LA-950V2, manufactured by Horiba, Ltd.)

Particle refractive index: 1.53-0.1i

Dispersion medium: water

Dispersion medium refractive index: 1.33

Because the volume average particle diameter of the plate-like filler undergoes no substantial change in the melt kneading described below, the volume average particle diameter of the plate-like filler can be determined by measuring the volume average particle diameter of the plate-like filler prior to incorporation in the liquid crystal polyester composition.

The liquid crystal polyester composition of the present embodiment preferably contains the plate-like filler in an amount that is at least 45 parts by mass but not more than 82 parts by mass, more preferably at least 48 parts by mass but not more than 81 parts by mass, and even more preferably at least 49 parts by mass but not more than 80 parts by mass, per 100 parts by mass of the above liquid crystal polyester. Further, in another aspect, the amount of the plate-like filler may be at least 50 parts by mass but not more than 80 parts by mass.

### (Optional Components)

The liquid crystal polyester composition of the present invention may also contain other components that correspond with none of the fibrous filler, the plate-like filler or the liquid crystal polyester, provided the effects of the present invention are not impaired.

Examples of these other components include typical additives such as particulate inorganic fillers (such as silica, alumina, titanium oxide, boron nitride, silicon carbide and calcium carbonate); releasability improvers such as fluororesins and metal soaps; colorants such as dyes and pigments; antioxidants; thermal stabilizers; ultraviolet absorbers; antistatic agents; and surfactants. A carbon black is preferable as the colorant.

Further, more examples of these other components include components having an external lubricant effect such as higher fatty acids, higher fatty acid esters, metal salts of higher fatty acids, and fluorocarbon-based surfactants.

Furthermore; yet more examples of these other components include thermoplastic resins such as polyamides, polyesters other than liquid crystal polyesters, polyphenylene sulfides, polyetherketones, polycarbonates, polyphenylene ethers and modified products thereof, polysulfones, polyethersulfones and polyetherimides; and thermosetting resins such as phenol resins, epoxy resins and polyimide resins.

The amount of the above other components, when the amount of the liquid crystal polyester of the present embodiment is deemed to be 100 parts by mass, is preferably at least 0 parts by mass but not more than 20 parts by mass.

In another aspect, in those cases where the liquid crystal polyester composition of the present invention contains other components, the amount of those other components is preferably from 0 to 16% by mass relative to the total mass of the liquid crystal polyester composition.

The liquid crystal polyester composition of the present invention can be produced by blending the raw material components, and there are no particular limitations on the blending method used. For example, a method may be used in which the fibrous filler, the plate-like filler, the liquid crystal polyester, and any of the above other components as desired are each supplied individually to a melt kneader. Further, these raw material components may first be subjected to preliminary mixing using a mortar, Henschel mixer, ball mill, or ribbon blender or the like, and subsequently supplied to a melt kneader. Furthermore, pellets produced by melt kneading of the liquid crystal polyester and the fibrous filler, and pellets produced by melt kneading of the liquid crystal polyester and the plate-like filler may be mixed together in the desired blend ratio. A fibrous filler that has been coated or bundled with a thermoplastic resin such as a urethane resin, acrylic resin or ethylene/vinyl acetate copolymer, or with a thermosetting resin such as an epoxy resin may also be used as the fibrous filler.

Further, the liquid crystal polyester composition of the present invention can also be obtained by producing master batch pellets by blending the liquid crystal polyester, the fibrous filler and the plate-like filler, and then dry-blending these master batch pellets with pellets that do not contain the fibrous filler at the time of molding. In this case, the amounts of the fibrous filler and the plate-like filler following dry-blending should satisfy the prescribed amounts described above.

### <Molded Article>

A second aspect of the present invention is a molded article obtained by molding the liquid crystal polyester composition of the first aspect of the present invention described above.

The liquid crystal polyester composition exhibits excellent fluidity during molding, and is ideal for producing a molded article having superior mechanical strength. The method used for producing the molded article may be a conventional method such as an injection molding method.

The molded article of this embodiment is preferably a connector. A connector obtained by molding the liquid crystal polyester composition described above exhibits superior resistance to cracking, even when the wall thickness is thin.

Further, the connector is preferably a CPU socket.

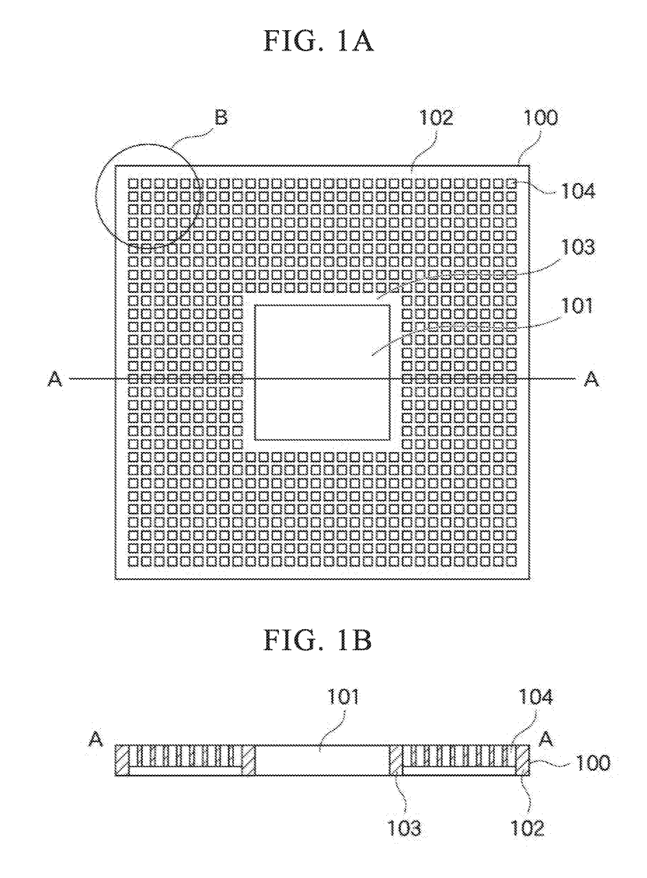

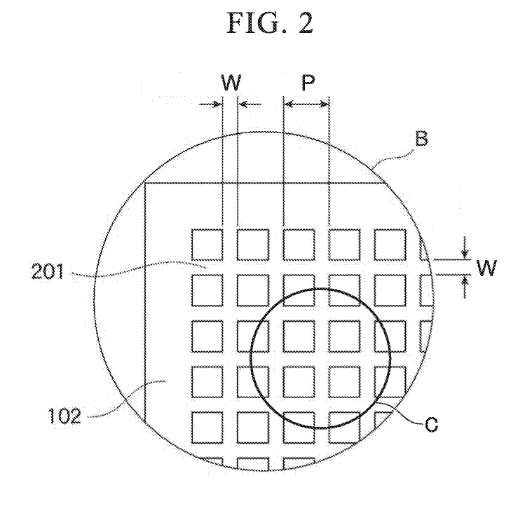

FIG. 1A is a schematic plan view illustrating a connector molded from the liquid crystal polyester composition described above, and FIG. 1B is a cross-sectional view along the line A-A in FIG. 1A. Further, FIG. 2 is an enlarged view of the region B in FIG. 1A.

The connector 100 illustrated in these figures is a CPU socket, which has a square plate-like form when viewed in plan view, and has a square opening 101 in the center. The outer peripheral portion and the inner peripheral portion of the connector 100 are formed with the back surface protruding, thus forming an outer frame 102 and an inner frame 103 respectively. Further, 794 μm insertion holes 104 each having a square shape in horizontal cross-section are provided in a matrix-like arrangement in the region sandwiched between the outer frame 102 and the inner frame 103. In this manner, the portions that separate the pin insertion holes 104, namely the minimum wall thickness portions 201, form an overall lattice shape.

The dimensions of the connector 100 in the field of view illustrated in FIG. 1A may be set as desired in accordance with the intended purpose, and for example, the external dimensions may be 42 mm×42 mm, with the dimensions of the opening 101 being 14 mm×14 mm.

Further, the thickness of the connector 100 in the field of view of FIG. 1B is 4 mm at the outer frame 102 and the inner frame 103, and 3 mm in the region sandwiched therebetween (namely, the thickness of the minimum wall thickness portions 201 in the enlarged view of FIG. 2).

The cross-sectional dimensions of each of the pin insertion holes 104 in FIG. 1A or FIG. 1B are 0.7 mm×0.7 mm, and the pitch P illustrated in the enlarged view of FIG. 2 (the sum of the cross-sectional width of one pin insertion hole 104 and the minimum distance between adjacent pin insertion holes 104) is 1 mm.

Furthermore, the width W of the minimum wall thickness portions 201 illustrated in the enlarged view of FIG. 2 (the lattice wall thickness, namely the shortest distance between adjacent pin insertion holes 104) is 0.2 mm. The dimensions described here are merely examples, and the number of the pin insertion holes 104 may also be set as desired in accordance with the intended purpose.

For example, in one aspect, the connector may have external dimensions from 40 mm×40 mm to 100 mm×100 mm, and the dimensions of the opening may be from 10 mm×10 mm to 40 mm×40 mm. The thickness of the connector may be from 2 mm to 6 mm at the outer frame and the inner frame, and may be from 2 to 5 mm in the region sandwiched therebetween (namely, the thickness of the minimum wall thickness portions). The cross-sectional dimension of each of the pin insertion holes in the connector may be from 0.2 to 0.5 mm, the pitch P may be from 0.8 to 1.5 mm, and the width of the minimum wall thickness portions may be from 0.1 to 0.4 mm.

When the connector 100 is produced by an injection molding method, the conditions include, for example, a molding temperature of 300 to 400° C., an injection speed of 100 to 300 mm/second, and an injection peak pressure of 50 to 150 MPa.

In other words, one aspect of the method for producing a molded article of the present invention comprises:

a step of obtaining a liquid crystal polyester composition by melt kneading a liquid crystal polyester, a fibrous filler having a number average fiber diameter of at least 15 μm but not more than 25 μm, a plate-like filler, and other components as desired, and

a step of subjecting the obtained liquid crystal polyester composition to injection molding under conditions including a molding temperature of 300 to 400° C., an injection speed of 100 to 300 mm/second, and an injection peak pressure of 50 to 150 MPa, wherein

the total amount of the fibrous filler and the plate-like filler in the liquid crystal polyester composition is at least 65 parts by mass but not more than 105 parts by mass per 100 parts by mass of the liquid crystal polyester.

The step of obtaining the liquid crystal polyester composition may be a step of obtaining the liquid crystal polyester composition by mixing pellets produced by melt kneading of the liquid crystal polyester and the fibrous filler, and pellets produced by melt kneading of the liquid crystal polyester and the plate-like filler.

The molded article molded from the liquid crystal polyester composition of the present invention is resistant to deformation under high-temperature conditions. Accordingly, the molded article molded from the liquid crystal polyester composition of the present invention has improved resistance to cracking, meaning the occurrence of cracking can be suppressed.

As a result, a connector obtained by molding the liquid crystal polyester composition described above is unlikely to suffer from cracking, even in the minimum wall thickness portions W illustrated in FIG. 2.

As described above, with a molded article obtained by molding the liquid crystal polyester composition of the present invention, the occurrence of cracking can be suppressed. Accordingly, by using a liquid crystal polyester composition of the present invention, even a molded article other than the connector or CPU socket described above that has a thin-walled portion within a portion of the molded article can be molded favorably.

Another aspect of the liquid crystal polyester composition of the present invention is:

a liquid crystal polyester composition comprising a liquid crystal polyester, a fibrous filler, a plate-like filler, and other components as desired; wherein the liquid crystal polyester comprises:
a repeating unit derived from p-hydroxybenzoic acid,

at least one repeating unit selected from the group consisting of a repeating unit derived from terephthalic acid and a repeating unit derived from isophthalic acid, and

a repeating unit derived from 4,4′-dihydroxybiphenyl;
the number average fiber diameter of the fibrous filler is at least 15 μm but not more than 25 μm, preferably at least 16 μm but not more than 24 μm, and more preferably at least 17 μm but not more than 23 μm;

the plate-like filler is at least one filler selected from the group consisting of talc and mica, and

has a volume average particle diameter of at least 15 μm but not more than 40 μm, preferably at least 20 μm but not more than 30 μm, and even more preferably at least 22 μm but not more than 28 μm;

the amount of the fibrous filler is at least 5 parts by mass but not more than 26 parts by mass, preferably at least 6 parts by mass but not more than 25 parts by mass, more preferably at least 7 parts by mass but not more than 24 parts by mass, and particularly preferably at least 9 parts by mass but not more than 23 parts by mass, per 100 parts by mass of the liquid crystal polyester;

the amount of the plate-like filler is at least 45 parts by mass but not more than 82 parts by mass, preferably at least 48 parts by mass but not more than 81 parts by mass, more preferably at least 49 parts by mass but not more than 80 parts by mass, and particularly preferably at least 50 parts by mass but not more than 80 parts by mass; per 100 parts by mass of the liquid crystal polyester;

the total amount of the fibrous filler and the plate-like filler is at least 65 parts by mass but not more than 105 parts by mass, preferably at least 70 parts by mass but not more than 90 parts by mass, more preferably at least 75 parts by mass but not more than 85 parts by mass, and even more preferably at least 78 parts by mass but not more than 83 parts by mass, or may be at least 67 parts by mass but not more than 100 parts by mass, per 100 parts by mass of the liquid crystal polyester; and the weight average fiber length of the fibrous filler is greater than 300 μm but less than 600 μm, and preferably greater than 350 μm but not more than 500 μm, or may be from 308 to 633 μm.

### EXAMPLES

The present invention is described below in further detail using a series of examples.

### Production Example 1

### Method for Producing Liquid Crystal Polyester 1

A reactor fitted with a stirring device, a torque meter, a nitrogen gas introduction tube, a thermometer and a reflux condenser was charged with 994.5 g (7.2 mol) of p-hydroxybenzoic acid, 299.1 g (1.8 mol) of terephthalic acid, 99.7 g (0.6 mol) of isophthalic acid, 446.9 g (2.4 mol) of 4,4′-dihydroxybiphenyl, 1,347.6 (13.2 mol) of acetic anhydride, and 0.2 g of 1-methylimidazole, the contents were stirred under a stream of nitrogen gas while the temperature was raised from room temperature to 150° C. over a period of 30 minutes, and were then refluxed at 150° C. for one hour. Subsequently, 0.9 g of 1-methylimidazole was added, the temperature was raised to 320° C. over a period of 2 hours and 50 minutes while by-product acetic acid and unreacted acetic anhydride were removed by distillation, the temperature was held at 320° C. until an increase in torque was confirmed, and the contents were then removed from the reactor and cooled to room temperature. The obtained solid was then crushed using a crusher, thus obtaining a powdered prepolymer. Subsequently, this prepolymer was heated, under an atmosphere of nitrogen gas, from room temperature to 250° C. over a period of one hour and then from 250° C. to 285° C. over a period of 5 hours, and was then held at 285° C. for 3 hours to effect a solid phase polymerization, before being cooled to obtain a powdered liquid crystal polyester 1. The flow starting temperature of this liquid crystal polyester was 327° C.

In this description, room temperature is from 20 to 25° C.

### Example 1

The liquid crystal polyester 1 obtained in the above production example 1, a glass fiber 2 having a number average fiber diameter of 17 μm, and a talc 1 were melt kneaded and pelletized at 340° C. in the proportions [parts by mass] shown in Table 1 using a twin-screw extruder (PCM-30HS, manufactured by Ikegai, Ltd., screw rotation: same direction, L/D=44).

The thus obtained pellets were injection molded using an injection molding machine (ROBOSHOT S-2000i 30B, manufactured by FANUC Corporation), under molding conditions including a cylinder temperature of 370° C. and a mold temperature of 130° C., thus obtaining a 1021 pin-compatible model CPU socket molded article.

### Example 2

With the exception of using the liquid crystal polyester 1 obtained in the above production example 1, a glass fiber 1 having a number average fiber diameter of 23 μm and a talc 2 in the proportions shown in Table 1, the same method as Example 1 was used to obtain a 1021 pin-compatible model CPU socket molded article.

### Comparative Examples 1 to 5

With the exception of using the liquid crystal polyester 1 obtained in the above production example 1, a glass fiber 3 having a number average fiber diameter of 11 μm, and either the talc 1 in Comparative Examples 1 to 4 or the talc 2 in Comparative Example 5 in the proportions [parts by mass] shown in Table 2, the same method as Example 1 was used to obtain 102.1 pin-compatible model CPU socket molded articles.

### (Measurement of Molded Article Cracking)

Cracking of the model CPU socket molded articles of Examples 1 and 2 and Comparative Examples 1 to 5 obtained using the method described above was measured using the following method.

First, five injection molded articles (1021 pin-compatible model CPU sockets) were prepared for each of the Examples 1 and 2 and Comparative Examples 1 to 5 obtained using the method described above, and a heat history was imparted to the five molded articles by heating the articles at 260° C. for 4 minutes and 40 seconds using an oven (DN63H, manufactured by Yamato Scientific Co., Ltd.). These temperature conditions represent the assumed temperature conditions for the reflow step when producing an electronic device using the CPU socket.

Following cooling of the molded articles to room temperature, a 15-fold zoom stereoscopic microscope (ZMM-45T2, manufactured by Sigma Koki Co., Ltd.) was used to inspect 5 samples (Examples 1 and 2, and Comparative Examples 4 and 5) or 3 samples (Comparative Examples 1 to 3) of the heated molded articles, the number of cracks that had occurred in the wall surfaces of each CPU socket was counted, and the value obtained by averaging the counted values was deemed the CPU crack count.

TABLE 1

| | | Example 1 | Example 2 |
|---|---|---|---|
| Liquid crystal polyester 1 | | 60 | 55 |
| Glass | Glass fiber 1 | — | 20 |
| fiber | (number average fiber diameter: 23 μm) | | |
| | Glass fiber 2 | 30 | — |
| | (number average fiber diameter: 17 μm) | | |
| | Glass fiber 3 | — | — |
| | (number average fiber diameter: 11 μm) | | |
| Talc | Talc 1 | 10 | — |
| | Talc 2 | — | 25 |

| | | |
|---|---|---|
| CPU crack count | 0.0 | 0.0 |

TABLE 2

| | | Comparative | Comparative | Comparative | Comparative | Comparative |
|---|---|---|---|---|---|---|
| | | Example 1 | Example 2 | Example 3 | Example 4 | Example 5 |
| Liquid crystal polyester 1 | | 60 | 58 | 58 | 60 | 55 |
| Glass fiber | Glass fiber 1 | — | — | — | — | — |
| | (number average | | | | | |
| | fiber diameter: 23 μm) | | | | | |
| | Glass fiber 2 | — | — | — | — | — |
| | (number average | | | | | |
| | fiber diameter: 17 μm) | | | | | |
| | Glass fiber 3 | 30 | 34 | 37 | 35 | 20 |
| | (number average | | | | | |
| | fiber diameter: 11 μm) | | | | | |
| Talc | Talc 1 | 10 | 8 | 5 | 5 | — |
| | Talc 2 | — | — | — | — | 25 |

| | | | | | |
|---|---|---|---|---|---|
| CPU crack count | 15.7 | 12.3 | 10.7 | 8 | 9.5 |

In Tables 1 and 2, details regarding each of the materials are as follows.

Glass fiber 1: CS03TAFT692, manufactured by Owens Corning Corporation (number average fiber diameter: 23 μm, chopped strands with a fiber length of 3 mm)

Glass fiber 2: ECS03T-747N, manufactured by Nippon Electric Glass Co., Ltd. (number average fiber diameter: 17 μm, chopped strands with a fiber length of 3 mm)

Glass fiber 3: CS3J-260S, manufactured by Nitto Boseki Co., Ltd. (number average fiber diameter: 11 μm, chopped strands with a fiber length of 3 mm)

Talc 1: Rose K, manufactured by Nippon Talc Co., Ltd. (volume average particle diameter: 17 μm)

Talc 2: NK-64, manufactured by Fuji Talc Industrial Co., Ltd. (volume average particle diameter: 23 μm)

Based on the results shown in Table 1, it is evident that the CPU sockets obtained in Examples 1 and 2 were favorable molded articles with absolutely no cracking.

In contrast, based on the results shown in Table 2, it is clear that the CPU sockets obtained in Comparative examples 1 to 5 had numerous cracks.

### Production Example 2

Method for Producing Liquid Crystal Polyester 2

A reactor fitted with a stirring device, a torque meter, a nitrogen gas introduction tube, a thermometer and a reflux condenser was charged with 994.5 g (7.2 mol) of p-hydroxybenzoic acid, 446.9 g (2.4 mol) of 4,4′-dihydroxybiphenyl, 299.1 g (1.8 mol) of terephthalic acid, 99.7 g (0.6 mol) of isophthalic acid, 1,347.6 (13.2 mol) of acetic anhydride, and 0.2 g of 1-methylimidazole, and the inside of the reactor was flushed thoroughly with nitrogen gas.

Subsequently, the contents were stirred under a stream of nitrogen gas while the temperature was raised from room temperature to 150° C. over a period of 30 minutes, and were then refluxed for 30 minutes while the same temperature was maintained.

Next, 2.4 g of 1-methylimidazole was added, the temperature was raised from 150° C. to 320° C. over a period of 2 hours and 50 minutes while by-product acetic acid and unreacted acetic anhydride were removed by distillation, and after holding the temperature at 320° C. for 30 minutes, the contents were removed from the reactor and cooled to room temperature.

The obtained solid was crushed using a crusher to a particle diameter of 0.1 to 1 mm, subsequently heated, under an atmosphere of nitrogen, from room temperature to 250° C. over a period of one hour and then from 250° C. to 295° C. over a period of 5 hours, and was then held at 295° C. for 3 hours to effect a solid phase polymerization. Following the solid phase polymerization, the product was cooled to obtain a powdered liquid crystal polyester 2. The flow starting temperature of the obtained liquid crystal polyester 2 was 312″C.

### Production Example 3

### Method for Producing Liquid Crystal Polyester 3

A reactor fitted with a stirring device, a torque meter, a nitrogen gas introduction tube, a thermometer and a reflux condenser was charged with 994.5 g (7.2 mol) of p-hydroxybenzoic acid, 446.9 g (2.4 mol) of 4,4′-dihydroxybiphenyl, 299.0 g (1.8 mol) of terephthalic acid, 99.7 g (0.6 mol) of isophthalic acid, and 1,347.6 (13.2 mol) of acetic anhydride, and the inside of the reactor was flushed thoroughly with nitrogen gas.

Subsequently, the contents were stirred under a stream of nitrogen gas while the temperature was raised from room temperature to 150° C. over a period of 30 minutes, and were then refluxed for 30 minutes while the same temperature was maintained.

Next, the temperature was raised from 150° C. to 320° C. over a period of 2 hours and 50 minutes while by-product acetic acid and unreacted acetic anhydride were removed by distillation, and after holding the temperature at 320° C. for 30 minutes, the contents were removed from the reactor and cooled to room temperature.

The obtained solid was crushed using a crusher to a particle diameter of 0.1 to 1 mm, subsequently heated, under an atmosphere of nitrogen, from room temperature to 250° C. over a period of one hour and then from 250° C. to 295° C. over a period of 5 hours, and was then held at 295° C. for 3 hours to effect a solid phase polymerization. Following the solid phase polymerization, the product was cooled to obtain a powdered liquid crystal polyester 3. The flow starting temperature of the obtained liquid crystal polyester 3 was 330° C.

### Production Example 4

### Method for Producing Liquid Crystal Polyester 4

A reactor fitted with a stirring device, a torque meter, a nitrogen gas introduction tube, a thermometer and a reflux condenser was charged with 996.8 g (6.0 mol) of p-hydroxybenzoic acid, 372.4 g (2.0 mol) of 4,4′-dihydroxybiphenyl, 298.9 g (1.8 mol) of terephthalic acid, 33.3 g (0.20 mol) of isophthalic acid, and 1,153 (11.0 mol) of acetic anhydride, and the inside of the reactor was flushed thoroughly with nitrogen gas.

Subsequently, the contents were stirred under a stream of nitrogen gas while the temperature was raised from room temperature to 150° C. over a period of 15 minutes, and were then refluxed for 180 minutes while the same temperature was maintained.

Next, the temperature was raised from 150° C. to 320° C. over a period of 2 hours and 50 minutes while by-product acetic acid and unreacted acetic anhydride were removed by distillation, and after holding the temperature at 320° C. for 30 minutes, the contents were removed from the reactor and cooled to room temperature.

The obtained solid was crushed using a crusher to a particle diameter of 0.1 to 1 mm, subsequently heated, under an atmosphere of nitrogen, from room temperature to 250° C. over a period of one hour and then from 250° C. to 320° C. over a period of 5 hours, and was then held at 320° C. for 3 hours to effect a solid phase polymerization. Following the solid phase polymerization, the product was cooled to obtain a powdered liquid crystal polyester 4. The flow starting temperature of the obtained liquid crystal polyester 4 was 362° C.

### <Production of Liquid Crystal Polyester Compositions>

### Examples 3 to 15, Comparative Examples 6 to 12

### (Production of Liquid Crystal Polyester Composition)

A total of 100 parts by mass of either one or two of the liquid crystal polyesters 2, 3 and 4 was added, in the mass ratio shown in Table 3 or 4, from a raw material supply port of a twin-screw extruder (PCM-30, manufactured by Ikegai, Ltd.) with the cylinder temperature set to 340° C., the fibrous filler (B) and the plate-like filler (C) were also supplied from a raw material supply port in the proportions shown in Table 3 or 4 together with the liquid crystal polyester, melt kneading was performed under conditions including a screw rotation rate of 150 rpm, and the product was discharged in a strand-like form through a circular nozzle (discharge port) having a diameter of 3 mm, passed through a water bath at a water temperature of 30° C. for 1.5 seconds, and then extracted with a take-off roller at a take-off speed of 40 m/min and pelletized using a strand cutter (manufactured by Tanabe Plastics Machinery Co., Ltd.) with the rotating blade set to 60 m/min, thus obtaining pellets of a liquid crystal polyester composition.

The various symbols shown in Table 3 and Table 4 mean the following materials.

### [Liquid Crystal Polyesters]

LCP2: the liquid crystal polyester 2 described above

LCP3: the liquid crystal polyester 3 described above

LCP4: the liquid crystal polyester 4 described above

### [Fibrous Fillers]

B1: chopped strand glass fiber, CS3J-260S manufactured by Nitto Boseki Co., Ltd., number average fiber diameter: 10 μm

B2: chopped strand glass fiber, CS03TAFT-692 manufactured by Nippon Electric Glass Co., Ltd., number average fiber diameter: 23 μm

B3: chopped strand glass fiber, ECS03T-747N manufactured by Nippon Electric Glass Co., Ltd., number average fiber diameter: 17 μm

### [Plate-Like Fillers]

C1: mica, YM-25S manufactured by Yamaguchi Mica Co., Ltd., volume average particle diameter: 25 μm

C2: mica, AB-25S manufactured by Yamaguchi Mica Co., Ltd., volume average particle diameter: 25 μm

D1: talc, Rose K manufactured by Nippon Talc Co., Ltd., volume average particle diameter: 17 μm

D2: talc, NK-64, manufactured by Fuji Talc Industrial Co., Ltd., volume average particle diameter: 23 μm

For the pellets obtained in Examples 3 to 15 and Comparative Examples 6 to 12, measurements and testing of the physical properties were performed using the following methods.

### (1) CPU Socket Molding

A CPU socket was injection molded from the obtained liquid crystal polyester composition pellets under the following molding conditions.

The shape of the molded CPU socket was as follows.

A planar connector having a lattice structure inside an outer frame, having an inner frame inside the lattice, and having an opening inside the inner frame, wherein the outer dimensions of the outer frame are 72 mm×72 mm, the thickness of the outer frame is 4.5 mm, the thickness of the inner frame is 3.0 mm, the inner dimensions of the inner frame are 28 mm×28 mm, the pitch in the lattice is 1.0 turn; the dimensions of the pin insertion holes are 0.6 mm×0.6 mm, and the pin count is 2,556 μms.

### [Molding Conditions]

Molding machine: FANUC ROBOSHOT S-2000i30B

Cylinder temperature:

360-360-350-340° C. (when using the liquid crystal polyesters 2 and 3)

370-370-360-350° C. (when using the liquid crystal polyester 4)

Mold temperature: 100° C.

Injection speed: 300 mm/sec

Holding pressure: 20 MPa

measurement: 53 mm

suck back: 5 mm

screw rotation rate: 100 rpm

screw back pressure: 1. MPa

gate: 4-point fan gate

### (2) Cracking Evaluation

Using a video microscope (VR-3000, manufactured by Keyence Corporation), the number of cracks that had occurred in the wall surfaces of the above molded CPU socket was measured. The measured value was deemed the crack count before reflow.

Subsequently, using a hotplate (PC-400D, manufactured by Corning Inc.), the same CPU socket was heated at 250° C. for 3 minutes. These temperature conditions represent the assumed temperature conditions for the reflow step when producing an electronic device using the CPU socket.

After cooling the CPU socket to room temperature, a video microscope (VR-3000, manufactured by Keyence Corporation) was used to inspect the CPU socket following heating, the number of cracks was measured, and the measured value was deemed the crack count after reflow. The difference between the crack count after reflow and the crack count before reflow was deemed the CPU socket crack count.

In the present examples, a CPU socket crack count of 35 or fewer was evaluated as a good result.

### (3) Warping Evaluation

Five CPU sockets were prepared using the method described above. For each CPU socket, a flatness measurement module (Core 9030c, manufactured by Cores Corporation) was used to measure the bottom surface of the molded CPU socket for warping at 2 mm intervals along the outer frame and the inner frame. In this measurement of the amount of warping, the least squares plane method was used to calculate an average value for the obtained amounts of warping (5 sets of data for each CPU socket), and this average value was deemed the amount of warping before reflow. The same CPU sockets were then subjected to reflow by heating from 25° C. to 250° C., holding at 250° C. for one minute, and then cooling to 50° C., the amount of warping of these CPU sockets after reflow was measured in the same manner as above, and the average value for the amount of warping was calculated. This average value was deemed the amount of warping after reflow.

In the present examples, CPU sockets having an amount of warping before reflow of not more than 0.35 mm were evaluated as good, and CPU sockets having an amount of warping after reflow of not more than 0.45 mm were evaluated as good.

The amount of warping determined by the least squares plane method means the value obtained by determining the least squares plane from the three-dimensional measurement data measured along the outer frame and the inner frame by the flatness measurement module, defining that reference plane as representing an amount of warping of 0, and then determining the maximum value for warping from that reference plane.

### (4) Measurement of Minimum Filling Pressure

In relation to the pressure during filling when molding the CPU socket, the filling pressure for the minimum filling required to obtain a good molded article was measured.

### (5) Blister Resistance Evaluation

Five CPU sockets molded in the manner described above were left to stand for 3 minutes in a forced convection constant-temperature oven (DN-63H, manufactured by Yamato Scientific Co., Ltd.) with the temperature set to 320° C., and the surface of the CPU sockets were checked for the existence of swelling. When one or more occurrences of swelling of 0.1 mm or more existed on the CPU socket surface, swelling was deemed to have occurred. Subsequently, the temperature of the forced convection constant-temperature oven was reduced in 10° C. intervals, with the existence of swelling on each surface of the five CPU sockets checked at each temperature, and the temperature at which no swelling existed was deemed the blister resistance temperature.

### (6) Measurement of Weight Average Fiber Length

One gram of pellets of the obtained liquid crystal polyester composition were incinerated by heating at 600° C. for 4 hours. The incinerated residue was dispersed in an ethylene glycol solution and after application of ultrasonic waves for 3 minutes, a video microscope (VHX-600, manufactured by Keyence Corporation) was used to measure 500 glass fiber strands at a magnification of 100×, and the weight average fiber length was calculated.

TABLE 3

| | | Example | | | | | | | | | | | | |
|---|---|---|---|---|---|---|---|---|---|---|---|---|---|---|
| | | 3 | 4 | 5 | 6 | 7 | 8 | 9 | 10 | 11 | 12 | 13 | 14 | 15 |
| LCP | LCP2 | 100 | 100 | 100 | 100 | 100 | 100 | 100 | 100 | 100 | 50 | | 100 | 100 |
| | LCP3 | | | | | | | | | | 50 | 100 | | |
| | LCP4 | | | | | | | | | | | | | |
| Glass fiber | B1 | | | | | | | | | | | | | |
| | B2 | | | | 18 | | | | | | | | | 36 |
| | B3 | 9 | 17 | 18 | | 18 | 22 | 22 | 23 | 20 | 18 | 18 | 50 | |
| Mica | C1 | 73 | 50 | 64 | 64 | 64 | 60 | 60 | | | 64 | 64 | | |
| | C2 | | | | | | | | 59 | 80 | | | | |
| Talc | D1 | | | | | | | | | | | | 17 | |
| | D2 | | | | | | | | | | | | | 45 |
| Weight average | μm | 528 | 499 | 633 | 352 | 449 | 434 | 604 | 580 | 564 | 388 | 308 | 410 | 464 |
| fiber length | | | | | | | | | | | | | | |
| CPU socket | number | 35 | 18 | 34 | 24 | 20 | 17 | 17 | 14 | 35 | 34 | 30 | 0 | 0 |
| crack count | | | | | | | | | | | | | | |
| Amount of | mm | 0.25 | 0.35 | 0.31 | 0.31 | 0.28 | 0.30 | 0.34 | 0.33 | 0.24 | 0.31 | 0.31 | 0.74 | 0.51 |
| warping before | | | | | | | | | | | | | | |
| reflow | | | | | | | | | | | | | | |
| Amount of | mm | 0.26 | 0.39 | 0.36 | 0.41 | 0.37 | 0.39 | 0.41 | 0.42 | 0.25 | 0.40 | 0.38 | 0.86 | 0.59 |
| warping after | | | | | | | | | | | | | | |
| reflow | | | | | | | | | | | | | | |
| Minimum | MPa | 55 | 62 | 63 | 65 | 62 | 63 | 67 | 67 | 65 | 69 | 75 | 77 | 72 |
| filling | | | | | | | | | | | | | | |
| pressure | | | | | | | | | | | | | | |
| Blister | ° C. | 300 | 300 | 300 | 310 | 300 | 300 | 310 | 310 | 300 | 300 | 310 | 320 | 320 |
| resistance | | | | | | | | | | | | | | |
| temperature | | | | | | | | | | | | | | |

TABLE 4

| | | Comparative Example | | | | | | |
|---|---|---|---|---|---|---|---|---|
| | | 6 | 7 | 8 | 9 | 10 | 11 | 12 |
| LCP | LCP2 | 100 | 92 | 100 | 100 | 100 | 100 | 50 |
| | LCP3 | | | | | | | 50 |
| | LCP4 | | 8 | | | | | |
| Glass fiber | B1 | | 25 | 22 | 20 | 18 | 18 | 18 |
| | B2 | | | | | | | |
| | B3 | | | | | | | |
| Mica | C1 | | 42 | 100 | | 64 | | |
| | C2 | 67 | | | 80 | | 64 | 64 |
| Talc | D1 | | | | | | | |
| | D2 | | | | | | | |
| Weight average fiber length | μm | — | 412 | — | 601 | 531 | 661 | 635 |
| CPU socket crack count | number | 55 | 45 | — | 43 | 44 | 40 | 45 |
| Amount of warping before reflow | mm | 0.43 | 0.39 | granulation | 0.25 | 0.28 | 0.27 | 0.32 |
| Amount of warping after reflow | mm | 0.72 | 0.44 | impossible | 0.33 | 0.36 | 0.35 | 0.44 |
| Minimum filling pressure | MPa | 57 | 61 | — | 64 | 63 | 62 | 67 |
| Blister resistance temperature | ° C. | 290 | 300 | — | 290 | 310 | 300 | 290 |

As shown in the above results, Examples 3 to 15 had few cracks, and exhibited excellent crack resistance. In contrast, Comparative Examples 6 to 12 had numerous cracks, and exhibited poor crack resistance.

Example 14 had a satisfactorily small crack count, but because the amount of the fibrous filler exceeded 26 parts by mass and the amount of the plate-like filler was less than 45 parts by mass, the amount of warping before and after reflow increased. Further, Example 15 had a satisfactorily small crack count, but because the amount of the fibrous filler exceeded 26 parts by mass, the amount of warping before and after reflow increased.

Example 5 had the same composition as Example 7, but because the weight average fiber length of the fibrous filler exceeded 600 μm, the amount of warping before and after reflow was greater when compared with Example 7. Further, Example 9 had the same composition as Example 8, but because the weight average fiber length of the fibrous filler exceeded 600 μm, the amount of warping before and after reflow was greater when compared with Example 8.

### INDUSTRIAL APPLICABILITY

The present invention can provide a liquid crystal polyester composition which, when molded into a molded article, is capable of improving the resistance to cracking in the molded article, and can also provide a molded article molded from the liquid crystal polyester composition, and is therefore useful industrially.

### DESCRIPTION OF THE REFERENCE SIGNS

100: Connector
101: Opening
102: Outer frame
103: inner frame
104: Pin insertion hole
201: Minimum wall thickness portion
P: Pin insertion hole pitch
W: Width of minimum wall thickness portion (thickness of lattice wall)

1. A liquid crystal polyester composition comprising a liquid crystal polyester, a fibrous filler having a number average fiber diameter of at least 15 μm but not more than 25 μm, and a plate-like filler, wherein a total amount of the fibrous filler and the plate-like filler is at least 65 parts by mass but not more than 105 parts by mass per 100 parts by mass of the liquid crystal polyester.

2. The liquid crystal polyester composition according to claim 1, wherein per 100 parts by mass of the liquid crystal polyester, an amount of the fibrous filler is at least 5 parts by mass but not more than 26 parts by mass, and an amount of the plate-like filler is at least 45 parts by mass but not more than 82 parts by mass.

3. The liquid crystal polyester composition according to claim 1, wherein a weight average fiber length of the fibrous filler is greater than 300 μm but not more than 600 μm.

4. The liquid crystal polyester composition according to claim 1, wherein a volume average particle diameter of the plate-like filler is at least 15 μm but not more than 40 μm.

5. The liquid crystal polyester composition according to claim 1, wherein the plate-like filler is a mica.

6. A molded article molded from the liquid crystal polyester composition according to claim 1.

7. The molded article according to claim 6, wherein the molded article is a connector.

8. The molded article according to claim 7, wherein the connector is a CPU socket.
